(19) United States
(12) Patent Application Publication
(10) Pub. No.: US 2008/0223756 A1
(43) Pub. Date: Sep. 18, 2008

(54) Surface-Rich Clays Used for the Production of Bleaching Earth, and Method for the Activation of Said Clays

(75) Inventor: Klaus Schurz, Munchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/916,821

(22) PCT Filed: Jun. 8, 2005
(86) PCT No.: PCT/EP2005/006174

§ 371 Date: Jun. 2, 2008

(51) Int. Cl. B01J 21/16; C10G 31/00

(52) U.S. Cl. 208/177; 502/80; 502/81

(57) ABSTRACT

A method for producing an adsorbing agent, an absorbing agent obtained by the method, and its use as bleaching earth, in particular for refining oils and fats, is described. In the method according to the invention, a raw clay with a specific surface area of more than 200 m²/g, an ion exchange capacity of more than 40 meq/100 g and a pore volume of more than 0.5 ml/g is used. At least 40% of the pore volume are provided by pores which have a pore diameter of at least 14 nm, and at most 25% of the pore volume are provided by pores which have a diameter of less than 7.5 nm. Surface activation with an acid gives an adsorbing agent which has a bleaching activity which partly exceeds that of high performance bleaching earths obtained by intensive dealuminization and washing with strong acid.

The invention relates to a method for producing an adsorbing agent, to an adsorbing agent obtained by the method, and to its use, and to a clay product.

In the industrial production of oils and fats, bleaching earths are used to remove clouding, discolorations or else for removing oxidation accelerators. Adsorptive purification can significantly improve taste, color and storage stability of the oils and fats. Various classes of bleaching earths are used for the purification. A first group is the class of high performance bleaching earths (HPBE), based mostly on montmorillonite. This group includes, in particular, acid-activated montmorillonites, the acid activation being carried out in a complex method by dealuminization of the raw clays with concentrated acids at high temperatures. In this method, a bleaching earth product with very large specific surface and large pore volume is obtained. Even the use of small amounts of this high performance bleaching earth leads to noticeable purification of the crude oils. Low use amounts in the bleaching process are desirable because the spent bleaching earth binds to the residual amounts of oil, as a result of which the yield is reduced, and, secondly, the spent bleaching earth has to be disposed of in accordance with current procedures.

The disadvantage of these high performance bleaching earths is the fact that the dealuminization with acid during the production produces large amounts of acidic salt-rich waste waters which can only be processed in complex processes or be disposed of. The high costs for the disposal of the waste waters as well as the complex production method account for the comparatively high prices of such high performance bleaching earths.

A further group is the class of naturally active clays. These naturally occurring bleaching earths have been used for centuries for the purification of fats and oils. These naturally active systems (so-called fuller's earth) can be made available very cost-effectively. However, they only have a low bleaching power, meaning that they are in most cases not suitable for the purification of oils and fats which are difficult to bleach. In addition, compared with high performance bleaching earths, significantly larger amounts of the adsorbing agent have to be used in order to achieve the desired bleaching results. As a result, however, higher losses of oil or fat have to be accepted since the bleaching earths cannot be separated off in pure form and certain amounts of oil or fat remain in the bleaching earth.

A compromise between low production costs and acceptable activity is provided by the third class of bleaching earth, the so-called surface modified systems (SMBE=surface modified bleaching earth). Here, a naturally active raw clay is supplied with small amounts of acid and thus an “in situ activation” is achieved. For this method, raw clays containing attapulgite and hormite in particular have proven useful. These have a really high specific surface for natural raw clays of about 100 to 180 m²/g and a pore volume of about 0.2 to 0.35 ml/g. However, since salts formed during the acid activation or unreacted acid fractions are not washed out, these remain on the product and are at least sometimes also deposited in the pores. As a result, these acid-activated bleaching earths generally do not achieve the same efficiency as is achieved by high performance bleaching earths (HPBE) which are produced by dealuminization with acid. The simple production method, however, permits a comparatively cost-effective production since no acidic waste waters are produced.

U.S. Pat. No. 5,008,226 discloses a method for producing acid-activated bleaching earth using a naturally occurring acidic attapulgite clay in accordance with the acid activation described above. This clay has a pore volume in the range from 0.25 to 0.50 ml/g and a specific surface in the range form 100 to 150 m²/g. Particular preference is given to using a naturally occurring mixture of attapulgite and bentonite. The main components of this mineral consist of 71 to 75% by weight of SiO₂ and of 11 to 16% by weight of Al₂O₃. The attapulgite/bentonite mineral is supplied with acid, corresponding to an acid amount of 1 to 10% by weight, at a temperature of about 25 to 100° C. The acid-activated intermediate is not washed, but used directly as bleaching earth after drying and grinding.

U.S. Pat. No. 3,029,783 describes a method of treating an attapulgite clay with acid. The attapulgite comprises about 15% by weight of Al₂O₃. The acid-activated clay is suitable for use as cat litter.

U.S. Pat. No. 5,869,415 describes a method for activating sheet silicates with an ion exchange capacity of at least 25 meq/100 g by activation with 1 to 10% by weight of acid and subsequent calcination at temperatures of 200° C. to 400° C. The sheet silicates have specific surfaces in the range from 132 to 167 m²/g, and a pore volume in the range from 0.27 to 0.35 ml/g and an ion exchange capacity of 38 to 68 meq/100 g.

WO 99/02256 describes a method for producing a bleaching earth with an increased acid content. The activation takes place here in an environmentally friendly, i.e. nonaqueous, process. Preferably, 2.5 to 5% by weight of acid in aqueous solution are added to predried and ground raw clay. Examples of suitable acids that are described are hydrochloric acid and phosphoric acid and also citric acid, which are applied to a raw clay from the palygorskite smektite class.

The above-described production of acid-activated bleaching earths i.e, sheet silicates, in particular smektites and palygorskites or mixtures of these silicates are thus usually used. The raw clays used as starting materials have specific surfaces in the range from 100 to 180 m²/g, a pore volume in the range from 0.25 to 0.50 ml/g and an ion exchange capacity in the range from 38 to 68 meq/100 g. These sheet silicates have an Al₂O₃ content of >11% by weight.

As already explained above, surface-modified bleaching earths (SMBE) have the advantage of a cost-effective production. However, they do not achieve the bleaching effect as is achieved by high performance bleaching earths (HPBE). Therefore, compared with the high performance bleaching earths, larger amounts of surface-modified bleaching earth are required in order to achieve a desired bleaching result. This in turn means that during bleaching by adsorption of oils and fats in the bleaching earth, higher oil losses have to be accepted, and on the other hand relatively large amounts of spent bleaching earth have to be processed and/or disposed of.

An object of the invention is therefore to provide a method for producing an adsorbing agent which avoids the disadvantages of the prior art and leads to a product with a high adsorption capacity, in particular with regard to the bleaching effect of oils and fats.

This object is achieved with a method having the features of patent claim 1. Advantageous embodiments of the method are the subject of the dependent claims.

Surprisingly, it has been found that when using the raw clays defined in claim 1, through a comparatively simple activation, adsorption agents and/or bleaching earths are obtainable whose activity is comparable and sometimes superior to that of high performance bleaching earths obtained by intensive dealuminization with strong acids.

Here, it is essential to the invention that the raw clay used has a specific surface (BET area) of more than 200 m²/g, an ion exchange capacity of more than 40 meq/100 g, and a pore volume of more than 0.5 ml/g, where at least 40% of the pore volume are provided by pores which have a pore diameter of at least 14 nm, and at most 25% of the pore volume are provided by pores which have a diameter of less than 7.5 nm.

Suitable analytical methods for determining the specific surface area, the pore volume and the ion exchange capacity are given below in the examples.

Preferably, at most 20%, in particular at most 15%, of the pore volume of the raw clay are provided by pores which have a pore diameter of less than 7.5 nm. Preferably, the pore volume fraction of the total pore volume which is provided by pores with a pore diameter in the range from 7.5 to 14 nm is at most 25%, preferably at most 15%, especially preferably at most 10%. Preferably, the pore volume fraction of the total pore volume which is provided by pores with a pore diameter in the range from 14 to 25 nm is at most 25%, preferably at most 20%, in particular at most 15%. Preferably, the pore volume fraction of the total pore volume which is provided by pores with a pore diameter in the range from 25 to 80 nm is at least 25%, preferably at least 30%, particularly preferably at least 40%. Preferably, the pore volume fraction of the total pore volume which is provided by pores with a pore diameter of at least 25 nm is at least 30%, preferably at least 40%, particularly preferably at least 50%, and very particularly preferably at least 60%. Preferably, the pore volume fraction of the total pore volume which is provided by pores with a pore diameter of more than 80 nm is at most 30%, preferably at most 25%, particularly preferably at most 25%. The raw clay used in the method according to the invention has a high fraction of medium-sized or large pores. This differentiates it, for example, from high performance bleaching earths which are produced by acid leaching. These high performance bleaching earths have a higher fraction of smaller pores.

Particular preference is given to using raw clays whose ion exchange capacity is above 50 meq/100 g, preferably in the range from 55 to 75 meq/100 g. Preferably, the raw clay has a specific surface (BET) in the range from 200 to 280 m²/g, particularly preferably in the range from 200 to 260 m²/g. The (total) pore volume (specific pore volume) of the raw clay used is preferably in the range from 0.7 to 1.0 ml/100 g, in particular in the range from 0.80 to 1.0 ml/100 g.

Preferably, the raw clay used in the method according to the invention has a fraction of heavy metals As, Pb, Cd, Hg that can be leached out by tartaric acid of less than 25 ppm, preferably less than 15 ppm, particularly preferably less than 10 ppm. The fraction of arsenic that can be leached out by tartaric acid is preferably less than 1.5 ppm, preferably less than 1 ppm. The fraction of lead that can be leached out by tartaric acid is preferably less than 5 ppm, preferably less than 4 ppm. The fraction of cadmium that can be leached out by tartaric acid is preferably less than 0.5 ppm, preferably less than 0.3 ppm and the fraction of mercury that can be leached out by tartaric acid is preferably less than 0.2 ppm, preferably less than 0.1 ppm.

A method for determining the fraction of heavy metals that can be leached out by tartaric acid is given in the examples.

Preferably, the sediment volume of the raw clay in water is less than 10 ml/2 g, i.e. the raw clay virtually does not swell in the presence of water. As a result, the bleaching earth product can be distributed very evenly within the crude oil and, after the bleaching process, can also be very readily separated off again by filtration.

In order to obtain an adsorbing agent or a bleaching earth with the desired properties, the raw clay is subjected to an activation, in particular an acid activation.

An activation is understood as meaning the treatment of the raw clay as is customary in the production of SMBE. Such methods are known per se to the person skilled in the art. They can consist in a thermal treatment or, in particular, in a treatment with acid. During the activation, the mineral structure of the raw clay preferably remains essentially intact. Experience has shown that the specific surface and the pore volume of the raw clay can decrease by up to about 20% depending on the type of acid activation.

In the method according to the invention, a dried raw clay is firstly provided. For the purposes of the present invention, raw clay is understood as meaning a naturally active or non-naturally active clay material, the intention being that clay materials further processed by conventional, mechanical or chemical work-up steps, but, in delimitation to the bleaching earths, not activated in a (separate) activation step, are to be included. Activation of the raw clay is to be understood here as meaning a treatment which leads to an improvement in the bleaching effect, especially in the case of the bleaching of oils and fats, as is determined using the color numbers in oils (Lovibond color numbers) according to AOCS Cc 13b-45 and/or the chlorophyll A determination in accordance with AOCS Cc 13d-55.

Correspondingly, for the purposes of the present invention, bleaching earths are understood as meaning a clay material that has been activated (in an activation step), in particular that has been activated by thermal and/or acid treatment. The term bleaching earth is known to the person skilled in the art and covers activated clay materials which, on account of their adsorption activity and/or bleaching activity, can be used for the purification in particular of food oils and fats.

In particular, raw clays are presently understood as meaning naturally occurring naturally active or non-naturally active clay materials which have not yet been subjected to a chemical modification, e.g. have not yet been coated with strong acids or dealuminized. Before the activation, the raw clays can, if appropriate, be dried and ground.

Particular preference is given to using raw clays whose content of aluminum, based on the anhydrous raw clay and calculated as Al₂O₃, is less than 11% by weight.

Particular preference is given to using raw clays which only have low crystallinity, i.e. are per se not assigned to the class of sheet silicates. The low crystallinity can be established, for example, by X-ray defractometry. The particularly preferred raw clays here are largely X-ray-amorphous, they therefore do not belong to the class of attapulgites or smektites.

Compared with conventional high performance bleaching earths, the raw clay used in the method according to the invention has a different pore distribution. In high performance bleaching earths, the pore volume is essentially formed by pores with a small diameter. The pores essentially have a diameter in the range from 2 to 14 nm. In contrast to this, in the raw clay used in the method according to the invention, the significant fraction of the pore volume is formed by pores which have an essentially larger diameter.

It is a characteristic of the raw clays used according to the invention that at least 40% of the total pore volume (determined in accordance with the BJH method, cf. below) are formed by pores which have a pore diameter of more than 14 nm. Preferably, more than 50%, and particularly preferably more than 60% of the total pore volume are formed by pores which have a diameter of more than 14 nm. The total pore volume of these raw clays is, as already explained, more than 0.5 ml/g. The pore radius distribution or the total pore volume is determined by nitrogen porosimetry (DIN 66131) and evaluation of the adsorption isotherms in accordance with the BJH method (cf. below).

It has been found that raw clays with the properties described above can be converted even through activation with small amounts of acid, as, for example, in the case of the abovementioned “in situ activation”, into bleaching earth products which have surprisingly good bleaching properties. The bleaching effect of these bleaching earth products achieves the results of high performance bleaching earths or even surpasses them. “In situ activation” is understood as meaning an activation treatment of the raw clay as is customary in the case of the above described acid-activated bleaching earths (SMBE).

In general, the activation according to the invention of the raw clays can be carried out by a treatment with acid. For this purpose, the raw clays are brought into contact with an inorganic or organic acid. In principle, any method for the acid activation of clays known to the person skilled in the art can be used here, including the methods described in WO 99/02256, U.S. Pat. No. 5,008,226 and U.S. Pat. No. 5,869,415, which are in this regard expressly incorporated into the description by reference.

According to a preferred embodiment according to the invention, it is not necessary for the excess acid and the salts which form during the activation to be washed out. Rather, after charging the acid, as is customary during acid activation, no washing step is carried out, but the treated raw clay is dried and then ground to the desired particle size. During grinding, a typical bleaching earth fineness is established in most cases. Here, the dry sieve residue on a sieve with a mesh width of 63 μm is in the range from 20 to 40% by weight. The dry sieve residue on a sieve with a mesh width of 25 μm is in the range from 50 to 65% by weight.

In one embodiment of the method according to the invention, the activation of the raw clay is carried out in an aqueous phase. To this end, the acid is brought into contact in the form of an aqueous solution with the raw clay. The procedure here may be such that firstly the raw clay, which is preferably provided in the form of a powder, is slurried in water. Then, the acid is added in concentrated form. However, the raw clay can also be slurried directly in an aqueous solution of the acid, or the aqueous solution of the acid can be added to the raw clay. According to an advantageous embodiment, the aqueous acid solution can, for example, be sprayed on to a preferably broken or pulverulent raw clay, in which case the amount of water is preferably chosen to be as small as possible and, for example, a concentrated acid or acid solution is used. The amount of acid can be chosen preferably between 1 and 10% by weight, particularly preferably between 2 and 6% by weight, of a strong acid, in particular of a mineral acid such as sulfuric acid, based on the anhydrous raw clay (bone dry). If necessary, excess water can be evaporated off and the activated raw clay can then be ground to the desired fineness. As already explained above, no washing step is required in this embodiment of the method according to the invention either. After addition of the aqueous solution of the acid only drying is carried out, if necessary, until the desired moisture content is reached. In most cases, the water content of the resulting bleaching earth product is adjusted to a fraction of less than 20% by weight, preferably less than 10% by weight.

For the above-described activation with an aqueous solution of an acid or of a concentrated acid, the acid can be selected arbitrarily. It is possible to use either mineral acids, or organic acids or mixtures of the above acids. Customary mineral acids can be used, such as hydrochloric acid, phosphoric acid or sulfuric acid, with sulfuric acid being preferred. Concentrated or dilute acids or acid solutions can be used. Organic acids which can be used are solutions of, for example, citric acid or oxalic acid. Preference is given to citric acid.

The particle size or the average particle size of the adsorbing agent according to the invention should preferably be selected so that, when the activated raw clay or the bleaching earth is used later on, it is possible to completely and simply remove the clay from the refined product. Preferably, the average particle size of the pulverulent raw clay is chosen in a range from 10 to 63 μm. Typically, the fineness is chosen such that on a sieve with a mesh width of 63 μm, about 20 to 40% by weight of the mixture remain (sieve residue) and on a sieve with a mesh width of 25 μm, about 50 to 65% by weight of the mixture remain. This can be referred to as typical bleaching earth fineness.

As already explained, the method according to the invention can be used, in a simple and cost-effective manner, to provide adsorbing agents and bleaching earth products whose adsorption activity or bleaching activity is surprisingly high and in some respects exceeds the activity of conventional high performance bleaching earths.

The invention therefore also provides an adsorbing agent, in particular a bleaching earth product, which is obtainable using the method described above. The adsorbing agents according to the invention can be produced in a cost-effective manner since, for example, no waste products are formed which have to be disposed of in a complex manner. As a result of their high bleaching activity, the adsorbing agents according to the invention allow the amounts which are required for the refining of, for example, oils and fats to be significantly reduced. As a consequence of this, the losses of starting material such as oils and fats which, upon separating off the adsorbing agent, remain therein, can also be significantly reduced.

The invention therefore also provides the use of the adsorbing agent described above as a bleaching earth. In this connection, particular preference is given to using the adsorbing agent described above for the refining of oils and fats, in particular for the refining of vegetable oils. Furthermore, the adsorbing agent according to the invention can also be used as drying agent or for the adsorption of gases.

The raw clay used for the production of the adsorbing agent according to the invention has even by itself advantageous properties, such as its easy and high activatibility with acid. The invention therefore also provides a clay product comprising a raw clay with
a specific surface of more than 200 m²/g;
an ion exchange capacity of more than 40 meq/100 g; and
a specific pore volume of more than 0.5 ml/g, where at least 40% of the pore volume are provided by pores which have a pore diameter of at least 14 nm, and at most 25% of the pore volume are provided by pores which have a diameter of less than 7.5 nm.

The specific surface (BET area) and the specific pore volume are determined using nitrogen porosimetry in accordance with DIN 66131. The specific surface is preferably in the range from 200 to 270 m²/g, particularly preferably in the range from 200 to 260 m²/g. The specific pore volume is preferably 0.5 to 1.0 ml/g, particularly preferably 0.7 to 1.0 ml/g. The ion exchange capacity is determined using the method described below in the examples. It is preferably more than 50 meq/100 g and is particularly preferably in the range from 55 to 75 meq/100 g. A slurry of 10% by weight of the raw clay in water preferably has a pH in the range from 5.5 to 8.5, preferably 5.9 to 8.2. The pH is determined using a pH electrode.

As already explained, the raw clay has a characteristic distribution of the pore radii. At least 40% of the pore volume is furnished by pores with a diameter of more than 14 nm. Preferably at least 50% of the pore volume, particularly preferably at least 60% of the pore volume, are furnished by pores with a diameter of at least 14 nm. The pore size and the pore size distribution can be determined by nitrogen porosimetry in accordance with DIN 66131 and evaluation by means of the BJH method. The total pore volume refers to pores with a diameter from 2 to 130 nm. The clay product consists preferably to at least 98%, particularly preferably to 100%, of raw clay. Particularly preferred values of the raw clay or of the clay product as regards the porosimetry, the sediment volume and the content of metals that can be leached out with tartaric acid have already been given above.

Furthermore, the invention relates to a method for the refining of fats and/or oils, where
a crude oil is provided which is obtained from a vegetable or animal material;
the crude oil is subjected to a bleaching by treating it with a bleaching earth product which comprises a raw clay which has
   a specific area of more than 200 m²/g;
   an ion exchange capacity of more than 40 meq/100 g; and
   a pore volume of more than 0.5 ml/g, where at least 40% of the pore volume are provided by pores which have a pore diameter of at least 14 nm, and at most 25% of the pore volume are provided by pores which have a diameter of less than 7.5 nm, and
the bleached oil is separated off from the bleaching earth product.

Using the bleaching earth product used in the method according to the invention it is possible to achieve a considerable reduction in the Lovibond color number and simultaneously a significant reduction in the content of phosphorus and iron. The method according to the invention therefore permits a rapid and simple refining of oils and fats.

Usually, during the refining of oils, the crude oils are firstly subjected to a degumming in order to remove gums from the oil. To this end, the oil is treated at temperatures in the range from 70 to 80° C. with water, during which stirring is carried out for about 10 to 20 minutes at atmospheric pressure. After separating off the gums, for example by means of a centrifuge, an acid degumming follows, during which the predegummed oil is treated with acid, in particular phosphoric acid or citric acid, at temperatures in the range from 70 to 100° C. at atmospheric pressure. Removal of the gums takes place together with the aqueous phase, for example by centrifugation. In the case of the acid degumming, at the end of the treatment time, water, mostly in amounts of 1-2% by weight, based on the crude oil, can be added in order to improve the degree of effectiveness of the degumming.

For the bleaching, the procedure may involve firstly carrying out a wet bleaching, in which the degummed oil is admixed with the bleaching earth and water and then the mixture is stirred at atmospheric pressure and a temperature of between about 80 and 100° C. After the wet bleaching, the pressure is reduced, the bleaching is continued at a pressure in the region of about 100 mbar and the temperature is, if appropriate, increased to the desired value, for example a temperature in the range from 90 to 120° C.

In the method according to the invention, under certain prerequisites, it is possible to dispense with the acid degumming and a wet bleaching and, after adding the bleaching earth product, to start directly with the vacuum bleaching.

This rationalized refining is suitable particularly for oils which have a phosphorus content, in particular phosphorus lipid content, of less than 100 ppm, preferably less than 50 ppm. The phosphorus content can be determined, for example, by elemental analysis.

In particular, the method according to the invention is suitable for the refining of palm oil.

The invention will be explained in more detail by reference to examples and by reference to an attached figure. What is shown is:

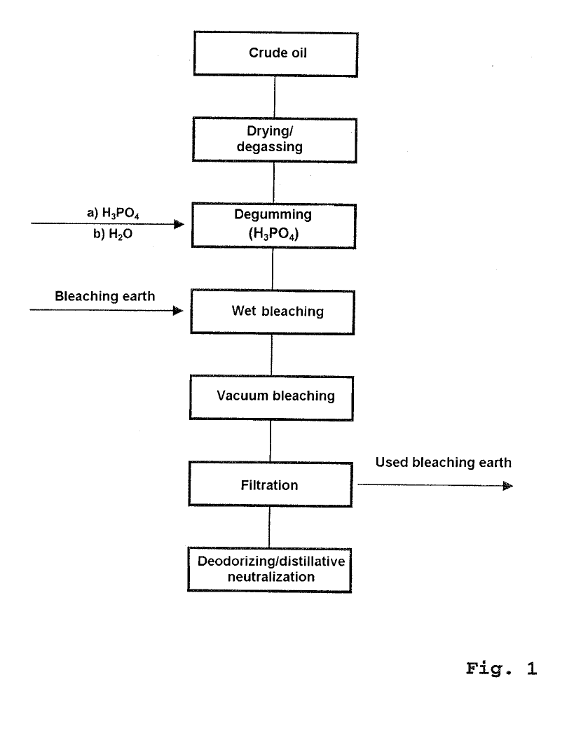

FIG. 1: a schematic process diagram for the physical refining of oils, in particular palm oil.

Crude food oil, for example palm oil, is usually refined according to the principle of physical refining by a method as shown schematically in FIG. 1. The crude oil, which has been obtained, for example, by pressing corresponding plant seeds in an oil mill, is, in the case of palm oil, firstly subjected to a drying and degassing in order to remove, for example, dissolved oxygen from the oil. The crude oil is passed to a degumming stage in which the gums, in particular phospholipids, are separated off. The degumming can involve a predegumming and an acid degumming. In the predegumming, water is added to the crude oil and the mixture is stirred at about 70 to 80° C. at atmospheric pressure. The aqueous lecithin phase is then separated off. After the predegumming, the crude oil has a phosphorus content in the range from about 100-200 ppm. During the acid degumming, the predegummed oil is admixed with an acid and stirred at about 70 to 100° C. at atmospheric pressure. Suitable acids are, for example, phosphoric acid and citric acid. Example conditions are an acid amount of 0.06% by weight of a 50% strength phosphoric acid, a treatment temperature of about 95° C. and a treatment time of about 15 minutes. At the end of the acid degumming, water may also be added, the amount of water chosen being about 0.2% by weight, in order to facilitate removal of the gums. The aqueous phase is then separated off, for example by a centrifugation. After the acid degumming, the oil has a phosphorus content in the range from about 10 to 20 ppm. The degumming is required in order, in combination with the subsequent bleaching, to reduce the fraction of phospholipids (gums) and also metals present in the oil. If the degumming is omitted, then the contents of phosphorus and iron are too high even at sufficiently low Lovibond color numbers red/yellow in the refined oil. After the degumming, the oil can, if necessary, be dried and degassed. For low-phosphorus crude oils, such as, for example, palm oil, it is possible, where appropriate, to dispense with the acid degumming and to carry out the bleaching directly.

The degumming is followed by a bleaching of the oil, where firstly a wet bleaching is carried out and then a vacuum bleaching. During the wet bleaching, the oil is admixed with water and bleaching earth, where amounts in the range from about 0.1 to 0.5% by weight for water and 0.3 to 2.0% by weight for bleaching earth are chosen. The oil is heated at atmospheric pressure to about 80 to 100° C. and stirred for about 20 minutes. A vacuum (for example 100 mbar) is then applied and the oil is stirred for a further 30 minutes at about 90 to 120° C. The oil is then filtered, for example over a suction filter covered with a paper filter. The filtration is carried out at a temperature of about 80° C.

After the bleaching, the oil is deodorized. To this end, superheated steam, which has an exit temperature of about 240 to 260° C., is passed through the oil in order to remove free fatty acids and unpleasant flavors and odors. The deodorization is carried out in vacuum at a pressure in the region of less than 5 mbar, preferably 1 to 3 mbar.

After the refining, the oil has a phosphorus content of less than 3 ppm and an iron content of less than 0.1 ppm.

In the case of the method according to the invention, the refining of the crude oil is carried out in the manner described above, but using a specific clay product as adsorbing agent or bleaching agent, particularly during the bleaching. For oils which have a phosphorus content of less than about 80 ppm, preferably less than 50 ppm, it is possible to dispense with the degumming step and, if appropriate, after drying and degassing the crude oil, to undertake a bleaching of the oil directly.

### EXAMPLES

The invention is further illustrated below by reference to examples.

The following analytical methods were used:

Surface/Pore Volume:

The specific surface was carried out on a fully automated nitrogen porosimeter from Micromeritics, model ASAP 2010, in accordance with DIN 66131. The pore volume was determined using the BJH method (E. P. Barrett, L. G. Joyner, P. P. Haienda, J. Am. Chem. Soc. 73 (1951) 373). Pore volumes of certain pore size ranges are determined by summing incremental pore volumes which are obtained from the evaluation of the adsorption isotherms according to the BJH method. The total pore volume in accordance with the BJH method refers to pores with a diameter of from 2 to 130 nm.

Oil Analysis:

The color numbers in oils (Lovibond color numbers) were determined in accordance with AOCS Cc 13b-45. The chlorophyll A determination was carried out in accordance with AOCS Cc 13d-55.

Water Content:

The water content of the products at 105° C. was determined using the method DIN/ISO-787/2.

Silicate Analysis:

This analysis is based on the total digestion of the raw clay or the corresponding product. Following the dissolution of the solids, the individual components are analyzed and quantified using conventional specific analytical methods, such as, for example, ICP.

Ion Exchange Capacity:

To determine the ion exchange capacity (IUF), the raw clay to be investigated was dried over a period of two hours at 105° C. The dried material was then reacted under reflux with an excess of an aqueous 2N NH₄Cl solution for one hour. After a standing time of 16 hours at room temperature, the mixture was filtered, and then the filter cake was washed, dried and ground and the NH₄ content in the raw clay was ascertained by nitrogen determination (CHN analyzer from Leco) in accordance with the manufacturers instructions. The fraction and the nature of the exchanged metal ions was determined in the filtrate by ICP spectroscopy.

X-ray Diffractometry:

The X-ray recordings are created on the high-resolution powder diffractometer from Phillips (X′-Pert-MPD(PW 3040)), which was equipped with a Cu anode.

Determination of the Sediment Volume

A graduated 100 ml measuring cylinder is filled with 100 ml of distilled water or an aqueous solution of 1% soda and 2% trisodium polyphosphate. 2 g of the substance to be measured are added slowly and in portions, in each case about 0.1 to 0.2 g, using a spatula on to the surface of the water. After one added portion has sunk, the next portion is added. After the 2 g of substance have been added and have sunk to the bottom of the measuring cylinder, the cylinder is left to stand for one hour at room temperature. The height of the sediment volume is then read off in ml/2 g on the graduation of the measuring cylinder.

Determination of the Volume Increase of the Sediment Volume (Swellability)

The sample mixture used as described above for determining the sediment volume is sealed with Parafilm® and left to stand for three days at room temperature without vibration. The sediment volume is then read off on the graduation of the measuring cylinder. The increase in the sediment volume is the difference between the sediment volume at the start of the measurement and after a standing time of three days.

Determination of the Dry Sieve Residue

About 50 g of the air-dry mineral to be investigated are weighed on to a sieve of mesh width 45 μm. The sieve is attached to a vacuum cleaner which, via a suction slit revolving below the base of the sieve, sucks out all of the fractions which are smaller than the sieve through the sieve. The sieve is covered with a plastic lid and the vacuum cleaner is switched on. After 5 minutes, the vacuum cleaner is switched off and the amount of relatively coarse fractions remaining on the sieve is determined by differential weighing.

Loss on Ignition:

In an annealed weighed porcelain crucible with lid, about 1 g of dried sample is weighed in exactly to 0.1 mg and strongly heated for 2 h at 1000° C. in a muffle furnace. The crucible is then cooled in the desiccator and weighed.

### Example 1

### Characterization of the Raw Clay

A raw clay suitable for the method according to the invention (Süd-Chemie A G, Moosburg D E, raw clay store ref. No.: 05041) was analyzed with regard to its physicochemical properties. The results achieved here are summarized in tables I to III.

TABLE I
Physicochemical analysis of the raw clay

| | |
|---|---|
| Specific surface (BET) (m²/g) | 213 |
| Pore volume (ml/g) | 0.85 |
| Cation exchange capacity (meq/100 g) | 54 |
| Sediment volume in water (ml/2 g) | <10 |
| Silicate analysis: | |
| SiO₂ (% by wt.) | 70.9 |
| Fe₂O₃ (% by wt.) | 2.7 |
| Al₂O₃ (% by wt.) | 9.6 |
| CaO (% by wt.) | 1.4 |
| MgO (% by wt.) | 4.3 |
| Na₂O (% by wt.) | 0.36 |
| K₂O (% by wt.) | 1.3 |
| TiO₂ (% by wt.) | 0.20 |
| Loss on ignition (2 h 1000° C.) | 7.7 |
| Total (% by weight) | 98.46 |

### Metal Leaching-Out in Tartaric Acid

2.5 g of the clay material characterized in table I (air-dried) are weighed into a 250 ml measuring flask and this is topped up to the calibration mark with 1% strength tartaric acid solution. The measuring flask is left to stand for 24 hours at room temperature and then the flask contents are filtered through a fluted filter. In the filtrate, the values given in table II are determined by means of AAS. For comparison, the limiting values according to the German wine law are also included.

TABLE II
Metal leaching-out in tartaric acid

| | In tartaric acid |
|---|---|
| As (ppm) | <1 |
| Pb (ppm) | 3 |
| Cd (ppm) | 0.1 |
| Hg (ppm) | <0.1 |
| Ca (%) | 0.92 |
| Fe (%) | 0.07 |
| Mg (%) | 0.22 |
| Na (%) | 0.04 |

The data show a very low metal leaching-out of the clay material. In particular, the clay material contains only very small amounts of heavy metals that can be leached out.

Furthermore, the clay material characterized in table I was investigated with regard to the fraction of the pore volume which is formed by pores with certain radii. The corresponding data are summarized in table III a to c.

TABLE IIIa
Relative fractions of pore volume

| Range | 0-75 Å | 0-140 Å | 0-250 Å | 0-800 Å | >800 Å |
|---|---|---|---|---|---|
| Fraction (%) | 10.3 | 19.3 | 34.1 | 78.0 | 22.0 |

TABLE IIIb
Relative fractions of pore volume

| Range | 0-75 Å | 75-140 Å | 140-250 Å | 250-800 Å | >800 Å |
|---|---|---|---|---|---|
| Fraction (%) | 10.3 | 9.0 | 14.8 | 43.9 | 22.0 |

TABLE IIIc
Relative fractions of pore volume

| Range | 0-75 Å | 75-800 Å | >75 Å | >140 Å | >250 Å | >800 Å |
|---|---|---|---|---|---|---|
| Fraction (%) | 10.3 | 67.7 | 89.7 | 80.7 | 65.9 | 22.0 |

### Example 2

### Activation of the Raw Clay with Sulfuric Acid

The raw clay characterized in example 1 was mixed with water and then activated with 3% by weight of H₂SO₄. For this purpose, 100 g of powder dried to 9.3% of H₂O were intimately combined with 208 g of water and 2.83 g of H₂SO₄ (96% strength) in a beaker. The resulting mixture was dried at 110° C. to a water content of 9.4% and then ground to a typical bleaching earth fineness (dry sieve residue on 63 μm sieve: 20 to 40% by weight; dry sieve residue on 25 μm sieve: 50 to 65% by weight).

### Comparative Example 1

### Sulfuric Acid Activation of Acidic Attapulgite/Bentonite for Producing a Bleaching Earth According to U.S. Pat. No. 5,008,226

A naturally occurring acidic mixture of attapulgite and bentonite from Georgia was predried to 15 to 20% by weight of H₂O, ground by means of a rotor beating mill and then dried to a water content of 8% by weight. 100 g of the resulting powder were intimately combined with 309 g of water and 2.88 g of H₂SO₄ (96% strength) in a beaker. The resulting mixture was dried at 110° C. to a water content of 9% by weight and then ground to a typical bleaching earth fineness. (Dry sieve residue on 63 μm sieve: 20 to 40% by weight; dry sieve residue on 25 μm sieve: 50 to 65% by weight).

### Comparative Example 2

### Reference Bleaching Earths According to the Prior Art

As reference for the highest performance bleaching earths (HPBE) accessed by dealuminization with acid, the commercially available bleaching earths Tonsil Optimum 210 FF and Tonsil Supreme 110 FF (Süd-Chemie A G) were chosen. Both products are produced by dealuminization of montmorillonite clays with hydrochloric acid.

As commercial product from Oil-Dri Supreme Pro Active was used as examples of conventional surface-modified bleaching earths (SMBE).

### Example 3

### Bleaching of Rapeseed Oil and Soybean Oil

A degummed and deacidified rapeseed oil or soybean oil was bleached with 0.30 or 0.73% by weight, respectively, of bleaching earth at 110° C. or 100° C., respectively, for 30 minutes under a pressure of 30 mbar. The bleaching earth was then filtered off and the color numbers of the oil were determined using the Lovibond method in a 5¼″. Some of this oil was additionally deodorized by steam treatment (30 minutes, 240° C., <1 mbar). The oil obtained here was also analyzed with the help of the Lovibond method. Tables IV and V give the results of the bleachings.

TABLE IV
Bleaching of rapeseed oil

| | Bleaching | | Deodorization | |
|---|---|---|---|---|
| | CN red | Chlorophyll | CN red | Chlorophyll |
| Sample | (5¼″) | A (ppm) | (5¼″) | A (ppm) |
| Tonsil Supreme 110F | 1.7 | 0.03 | 0.7 | 0.02 |
| Tonsil Optimum 210 FF | 2.6 | 0.09 | 1.0 | 0.9 |
| Tonsil Standard 3141 | 3.6 | 0.18 | 1.2 | 0.17 |
| FF | | | | |
| OD Supreme Pro-Active | 3.2 | 0.14 | 1.3 | 0.15 |
| Comparative example 1 | 3.4 | 0.13 | 1.3 | 0.16 |
| Example 2 | 2.2 | 0.02 | 0.55 | 0.01 |

TABLE V
Bleaching of soybean oil

| | Bleaching | | Deodorization | |
|---|---|---|---|---|
| | CN red | Chlorophyll | CN red | Chlorophyll |
| Sample | (5¼″) | A (ppm) | (5¼″) | A (ppm) |
| Tonsil Supreme 110F | 2.7 | 0.07 | 0.9 | 0.06 |
| Tonsil Optimum 210 FF | 3.6 | 0.11 | 1.0 | 0.10 |
| Tonsil Standard 3141 | 6.3 | 0.19 | 1.1 | 0.15 |
| FF | | | | |
| OD Supreme Pro-Active | 4.5 | 0.15 | 1.2 | 0.16 |
| Comparative example 1 | 4.6 | 0.22 | 1.3 | 0.20 |
| Example 2 | 4.5 | 0.08 | 0.7 | 0.08 |

As tables IV and V clearly show, an extraordinarily good decoloring of the oil (color number red and chlorophyll A) is achieved using the bleaching earth according to the invention in accordance with example 2. The values after the deodorization are of particular relevance here since in practice virtually all oils are deodorized after bleaching. The cleaning performance of the bleaching earths according to the invention is in the region of or better than the highest performance bleaching earths and significantly above the results of the surface-modified bleaching earths according to the prior art.

### Example 4

### Bleaching of Palm Oil

For carrying out the refining experiments, two different palm oils were used, the properties of which are summarized in table VI.

TABLE VI
Properties of the crude palm oils

| | | Palm oil A | Palm oil B |
|---|---|---|---|
| Lovibond color number red | ¼″ | 19.1 | 15.7 |
| Lovibond color number | ¼″ | >70 | >70 |
| yellow | | | |
| Phosphorus | ppm | 11 | 13 |
| Iron | ppm | 3.6 | 4.7 |

The crude palm oils were refined in the following ways:

a) Refining of palm oil A, with degumming:

For the refining of palm oil A, the dried and degassed crude palm oil was firstly admixed with 0.06% by weight of H₃PO₄ (50%) and the mixture was stirred at 95° C. for 15 minutes under atmospheric pressure. 0.2% of H₂O were then added and the mixture was stirred for a further 10 min under atmospheric pressure. After the degumming, the oil was admixed with 2% by weight of each of the bleaching earths given in table V. The mixture was firstly stirred at atmospheric pressure for 20 minutes at 95° C., then the pressure was lowered to 100 mbar and the mixture was stirred for a further 30 minutes at 95° C. After the bleaching, the oil was filtered at 80° C. through a suction filter which was lined with a filter paper.

The bleached oil was deodorized by passing, at a pressure of <1 mbar, firstly for 30 minutes, superheated steam (exit temperature: 270° C.) and then for a further 60 minutes, superheated steam (exit temperature: 240° C.) through the oil. The refined oil was then characterized. The values are likewise given in table VII.

b) Refining of palm oil A, without degumming

For the refining, the dried and degassed crude palm oil was admixed directly with 2.0% by weight of the bleaching earths given in table VII and the mixture was stirred at a pressure of 100 mbar and a temperature of 95° C. for 30 minutes. The mixture was then filtered and deodorized as stated in a). The values found for the refined palm oil are likewise given in table VII.

c) Refining of palm oil B, with degumming:

Palm oil B was firstly degummed as stated in a) and then, for bleaching, admixed with 1.35% by weight of each of the bleaching earths given in table VII. The mixture was firstly stirred at 95° C. for 20 minutes under atmospheric pressure. The temperature was then increased to 115° C. and the mixture was stirred at a pressure of 100 mbar for a further 25 minutes. The mixture was filtered at 80° C. through a suction filter which was lined with a filter paper. The deodorization of the bleached oil was carried out by firstly passing steam, which had an exit temperature of 270° C., through the oil for 30 minutes, and then treating the oil for a further 60 minutes at a pressure of <1 mbar with superheated steam which had an exit temperature of 240° C. The refined oil was then characterized. The values are likewise given in table VII.

d) Refining of palm oil B, without degumming

The dried and degassed palm oil B was admixed directly with 1.35% by weight of bleaching earth and the mixture was stirred at 115° C. for 25 minutes at 100 mbar. Following completion of the treatment, the oil was filtered at 80° C. through a suction filter which was lined with a filter paper. For the deodorization, superheated steam, which had an exit temperature of 270° C., was initially passed through the oil for 30 minutes. The deodorization was then continued by passing through superheated steam, which had an exit temperature of 240° C., for a further 60 minutes at a pressure of <1 mbar. The data of the refined perfume oils are given in table VII.

TABLE VII
Refining of palm oil

| | | | | Lovibond color numbers (PFX 995) | | | | | |
|---|---|---|---|---|---|---|---|---|---|
| | Bleaching earth | | | | | Fully refined | | | |
| Palm | | Dos. | | Bleaching (½″) | | product (5¼″) | | P | Fe |
| oil | Type | (%) | D/W | Red | Yellow | Red | Yellow | ppm | ppm |
| A | Supreme 190 FF | 2.00 | Yes | 9.6 | 70+ | 2.2 | 28 | <0.8 | <0.1 |
| | | ″ | — | 9.5 | 70+ | 1.9 | 23 | 0.9 | 0.2 |
| | Optimum 215 FF | 2.00 | Yes | 8.9 | 70+ | 2.3 | 35 | <0.8 | <0.1 |
| | | ″ | — | 8.3 | 70+ | 2.0 | 26 | 1.0 | 0.2 |
| | Example 2 | 2.00 | Yes | 16.5 | 70+ | 2.7 | 46 | <0.8 | <0.1 |
| | | ″ | — | 12.9 | 70+ | 2.3 | 35 | <0.8 | <0.1 |
| | Standard 310 FF | 2.00 | Yes | 13.5 | 70+ | 2.8 | 46 | 0.9 | <0.1 |
| | | ″ | — | 10.5 | 70+ | 2.6 | 31 | 2.8 | 0.8 |
| B | Optimum 215 FF | 1.35 | Yes | 7.6 | 70+ | 2.4 | 32 | <0.8 | <0.1 |
| | | ″ | — | 8.3 | 70+ | 2.3 | 29 | 3.2 | 0.7 |
| | Example 2 | 1.35 | Yes | 16.1 | 70+ | 2.6 | 39 | <0.8 | <0.1 |
| | | ″ | — | 13.4 | 70+ | 2.4 | 34 | <0.8 | <0.1 |
| | | 1.00 | — | 15.7 | 70+ | 2.6 | 39 | <0.8 | <0.1 |

D/S: Degumming/wet bleaching
Tonsil Supreme 190 FF, Optimum 215 FF, Standard 310 FF are products from Süd-Chemie AG, Munich

If the degumming is omitted, then even lower Lovibond color numbers are surprisingly obtained after deodorization than with degumming for all bleaching earths. With the exception of the examples in which the bleaching earth from example 2 was used, however, excessively high values for the content of phosphorus and iron in the oil are found. In the case of the oils bleached with the bleaching earth from example 2, both with and without degumming/wet bleaching, values for iron and phosphorus are found which are below the detection limit of 0.8 or 0.1 ppm. In the case of palm oil “B” it could be shown that a good refining result can also be achieved with a reduced dosing of 1.0% by weight.

1. A method for producing an adsorbing agent, in particular a bleaching earth product, comprising
activating a raw clay, wherein the raw clay has
a specific surface of more than 200 m²/g,
an ion exchange capacity of more than 40 meq/100 g, and
a pore volume of more than 0.5 ml/g, where at least 40% of the pore volume are provided by pores which have a pore diameter of at least 14 nm, and at most 25% of the pore volume are provided by pores which have a diameter of less than 7.5 nm.

2. The method as claimed in claim 1, where the ion exchange capacity of the raw clay is greater than 50 meq/100 g.

3. The method as claimed in claim 1, where the raw clay, based on anhydrous raw clay, has an Al_{2l O}₃ content of less than 11% by weight.

4. The method as claimed in claim 1, where the raw clay has an SiO₂ content, based on anhydrous raw clay, of more than 65% by weight.

5. The method as claimed in claim 1, where the raw clay has a fraction of heavy metals As, Pb, Cd, Hg that can be leached out by tartaric acid of less than 25 ppm.

6. The method as claimed in claim 5, where the fraction of arsenic that can be leached out by tartaric acid is less than 1.5 ppm and/or the fraction of the lead that can be leached out by tartaric acid is less than 5 ppm and/or the fraction of cadmium that can be leached out by tartaric acid is less than 0.5 ppm and/or the fraction of mercury that can be leached out by tartaric acid is less than 0.2 ppm.

7. The method as claimed in claim 1, where the sediment volume of the raw clay in water is less than 10 ml/2 g.

8. The method as claimed in claim 1, where the raw clay is brought into contact with an acid for the activation.

9. The method as claimed in claim 8, where the acid is brought into contact in the form of an aqueous solution with the raw clay.

10. The method as claimed in claim 8, where the acid comprises a mineral acid.

11. The method as claimed in claim 10, where the mineral acid comprises sulfuric acid or phosphoric acid.

12. (canceled)

13. (canceled)

14. (canceled)

15. A clay product comprising a raw clay with
a specific surface of more than 200 m²/g;
an ion exchange capacity of more than 40 meq/100 g; and
a pore volume, determined by nitrogen porosimetry, of more than 0.5 ml/g, where at least 40% of the pore volume are provided by pores which have a pore diameter of at least 14 nm, and at most 25% of the pore volume are provided by pores which have a diameter of less than 7.5 nm.

16. The clay product as claimed in claim 15, where the raw clay has a fraction of heavy metals As, Pb, Cd, Hg that can be leached out by tartaric acid of less than 25 ppm.

17. A method for the refining of fats and/or oils, comprising
providing a crude oil which is obtained from a vegetable or animal material;
subjecting the crude oil to bleaching by treating it with a bleaching earth product which comprises a raw clay which has
a specific area of more than 200 m²/g;
an ion exchange capacity of more than 40 meq/100 g; and
a pore volume of more than 0.5 ml/g, where at least 40% of the pore volume are provided by pores which have a pore diameter of at least 14 nm, and at most 25% of the pore volume are provided by pores which have a diameter of less than 7.5 nm, and
separating off the bleached oil from the bleaching earth product to produced the refined fats and/or oils.

18. The method as claimed in claim 17, where the crude oil has a phosphorus content, calculated as P, of less than 100 ppm.

19. The method as claimed in claim 17, where the crude oil is not subjected to a degumming.
